(19) United States
(12) Patent Application Publication
(10) Pub. No.: US 2014/0153075 A1
(43) Pub. Date: Jun. 5, 2014

(54) OPTICAL SIGNAL MODULATION

(71) Applicant: TELEFONAKTIEBOLAGET L M ERICSSON (PUBL), Stockholm (SE)

(72) Inventors: Antonio MALACARNE, Livorno (IT); Francesco FRESI, Pisa (IT); Jonathan KLAMKIN, Pisa (IT); Luca POTI, Pisa (IT)

(73) Assignee: Telefonaktiebolaget L M Ericsson (publ), Stockholm (SE)

(21) Appl. No.: 13/693,457

(22) Filed: Dec. 4, 2012

(51) Int. Cl. G02F 1/01

(52) U.S. Cl. CPC G02F 1/01
USPC 359/238

(57) ABSTRACT

A 2ⁿ quadrature amplitude modulation optical modulator has an optical input for receiving an optical signal. A first splitter is coupled to the optical input and has first and second outputs. A first optical modulation apparatus, coupled to the first output, applies a modulation scheme having 2ⁿ⁻² constellation points to produce a first modulated optical signal representing an in-phase component. A second optical modulation apparatus, coupled to the second output, applies a modulation scheme having 2ⁿ⁻² constellation point to produce a second modulated optical signal representing a quadrature component. An optical combiner combines the first and second modulated optical signals to produce an output modulated optical signal which is modulated with a modulation scheme having 2ⁿ constellation points.

### TECHNICAL FIELD

This invention relates to a 2ⁿ quadrature amplitude modulation (QAM) optical modulator, a method of 2ⁿ quadrature amplitude modulation and an optical signal transmission apparatus incorporating the 2ⁿ quadrature amplitude modulation optical modulator.

### BACKGROUND

In the light of recent achievements of coherent detection technologies in optical transmission systems together with the ever-growing need for higher data rates, a strong effort has been devoted to research into high-order modulation formats. In particular, both phase shift keying (PSK) and quadrature amplitude modulation (QAM) techniques allow for higher spectral efficiency, thus increasing the bit-rate.

Several architectures have been investigated for generating 16-QAM signals. The most straightforward method comprises driving a single-drive IQ modulator with two four-level signals which are significantly more challenging to either generate or process than binary signals. Alternatively, the use of more complex modulators can reduce the complexity of the driving signals. For instance, generation of 16-QAM signals from four binary signals has been proposed with either two parallel or two cascaded IQ modulators. An example is described by Guo-Wei Lu; Sakamoto, T.; Chiba, A.; Kawanishi, T.; Miyazaki, T.; Higuma, K.; Sudo, M.; Ichikawa, J.; “16-QAM transmitter using monolithically integrated quad Mach-Zehnder IQ modulator,” 36th European Conference Optical Communication (ECOC), 2010, Mo. 1.F.3 (2010). Recently, a solution employing a single dual-drive IQ modulator driven by binary signals with different amplitudes has been described by S. Yan, D. Wang, Y. Gao, C. Lu, A. P. T. Lau, L. Liu and X. Xu, “Generation of Square or Hexagonal 16-QAM Signals Using a Single Dual Drive IQ Modulator Driven by Binary Signals”, Proc. Optical Fiber Communication, (OFC) 2012, OW3H.3, 2012. However, the generated 16-QAM constellation exhibits a residual offset with respect to the origin of the complex I-Q plane, thereby reducing the energy efficiency.

### SUMMARY

An aspect of the present invention provides a 2ⁿ quadrature amplitude modulation optical modulator. The modulator comprises an optical input for receiving an optical signal. The modulator further comprises a first optical splitter coupled to the optical input, the first optical splitter having a first output and a second output. The modulator further comprises a first optical modulation apparatus coupled to the first output of the first optical splitter which is arranged to apply a modulation scheme having 2ⁿ⁻² constellation points to produce a first modulated optical signal representing an in-phase component. The modulator further comprises a second optical modulation apparatus coupled to the second output of the first optical splitter which is arranged to apply a modulation scheme having 2ⁿ⁻² constellation point to produce a second modulated optical signal, representing a quadrature component. The modulator further comprises an optical combiner for combining the first modulated optical signal and the second modulated optical signal to produce an output modulated optical signal which is modulated with a modulation scheme having 2ⁿ constellation points. Each of the first optical modulation apparatus and the second optical modulation apparatus comprises a dual-drive Mach Zehnder modulator having an input optical splitter with an unequal split ratio.

Another aspect of the invention provides an optical signal transmission apparatus comprising an optical source having an optical output for emitting an optical signal and a 2ⁿ quadrature amplitude modulation optical modulator.

Another aspect of the invention provides a method of 2ⁿ quadrature amplitude modulation comprising receiving an optical signal to be modulated. The method further comprises modulating a first portion of the received optical signal with a modulation scheme having 2ⁿ⁻² constellation points to produce a first modulated optical signal representing an in-phase component. The method further comprises modulating a second portion of the received optical signal with a modulation scheme having 2ⁿ⁻² constellation points to produce a second modulated optical signal representing a quadrature component. The method further comprises combining the first modulated optical signal and the second modulated optical signal to produce an output modulated optical signal which is modulated with a modulation scheme having 2ⁿ constellation points. Each of the modulating steps uses a dual-drive Mach Zehnder modulator which splits the received optical signal with an unequal split ratio.

### BRIEF DESCRIPTION OF THE DRAWINGS

Embodiments of the invention will be described, by way of example only, with reference to the accompanying drawings in which:

FIG. 1 schematically shows a 2ⁿ quadrature amplitude modulation optical modulator according to an embodiment;

FIG. 2 shows the optical modulator of FIG. 1 in more detail;

FIG. 3 shows generation of an optical signal in the in-phase arm of the modulator of FIGS. 1 and 2;

FIG. 4 shows constellations generated at the in-phase arm and quadrature arm and a constellation of the overall 16-QAM output;

FIG. 5 shows effect of splitting ratio inaccuracy on the constellation efficiency;

FIGS. 6A-6D show four possible tunable optical splitters which can be used in the optical modulator of the present invention;

FIG. 7 shows simulated normalized output power for one type of tunable splitter;

FIG. 8 shows constellations generated at the in-phase arm and quadrature arm and of the overall 16-QAM output for hexagonal 16-QAM;

FIG. 9 shows a method of quadrature amplitude modulation according to an embodiment.

### DETAILED DESCRIPTION

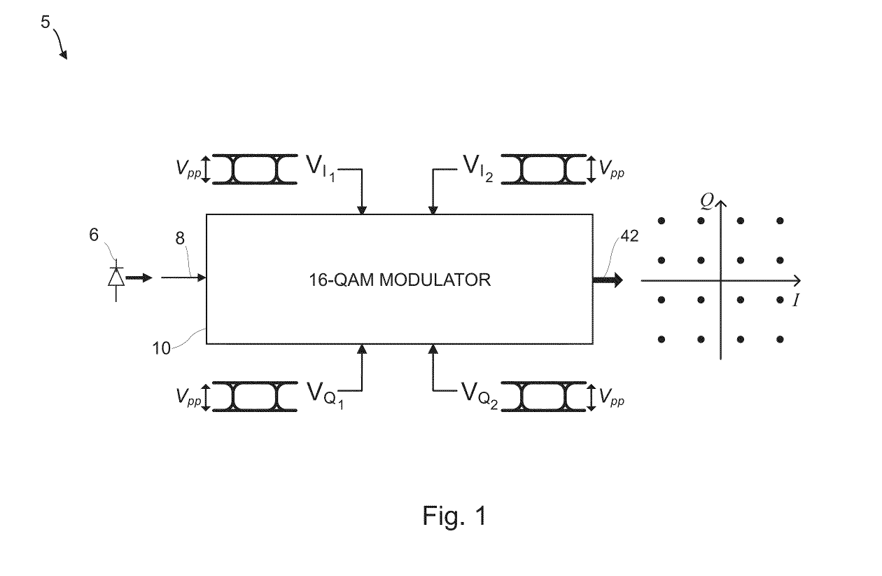

FIG. 1 schematically shows an optical signal transmission apparatus 5 according to an embodiment. The transmitter 5 comprises an optical source 6 for generating an optical signal and a 2ⁿ quadrature amplitude modulation (QAM) optical modulator 10 for modulating the optical signal. The optical signal source 6 can be a laser. For telecommunications applications, the wavelength of the optical signal is selected as a wavelength of an optical channel that is to be used to carry data. In the case of a 16-QAM modulator, a signal output 42 from the transmitter is modulated with a 16-QAM constellation and inputs to the transmitter 5 comprise four binary signals V_{I1}, V_{I2}, V_{Q1}, V_{Q2} which have the same peak-to-peak amplitude Vₚₚ.

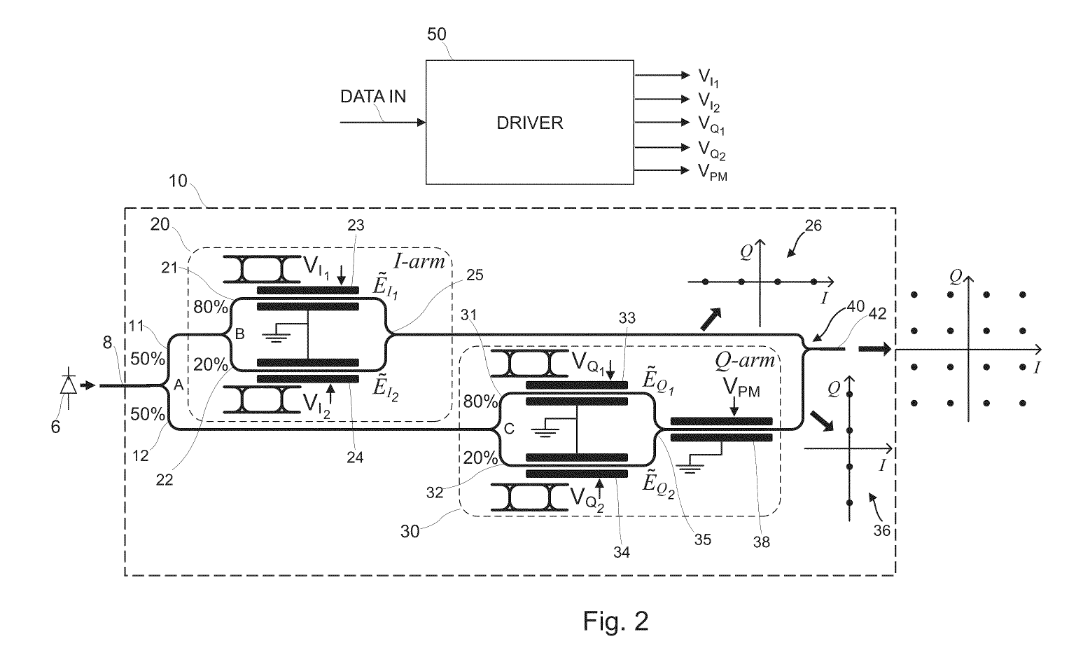

FIG. 2 shows an embodiment of the 2ⁿ quadrature amplitude modulation (QAM) optical modulator 10 in more detail. A first optical splitter A is coupled to the optical input 8 and has a first output 11 and a second output 12. The first optical splitter A divides light received from input 8 between the first output 11 and the second output 12. In this embodiment, splitter A equally divides light between the arms 11, 12 in an equal split ratio of 50/50 although, in other embodiments, the split ratio can be unequal.

The modulator 10 comprises a first modulation apparatus 20 on an in-phase arm (I-arm) and a second modulation apparatus 30 on a quadrature arm (Q-arm). The first optical modulation apparatus 20 has a first arm 21 with a first phase modulator 23 and a second arm 22 with a second phase modulator 24. An optical combiner 25 combines outputs of the arms 21, 22. Each phase modulator 23, 24 is driven by a respective signal V_{I1}, V_{I2}. Accordingly, the first modulation apparatus 20 is called a dual-drive Mach Zehnder modulator (MZM). The pair of phase modulators 23, 24 of the first modulation apparatus 20 form a nested MZI. Similarly, the second optical modulation apparatus 30 has a first arm 31 with a first phase modulator 33 and a second arm 32 with a second phase modulator 34. An optical combiner 35 combines outputs of the arms 31, 32. Each phase modulator is driven by a respective signal V_{Q1}, V_{Q2}. The second modulation apparatus 30 is another dual-drive Mach Zehnder modulator (MZM). The pair of phase modulators 33, 34 of the second modulation apparatus 30 form a nested MZI. Each of the phase modulators 23, 24, 33, 34 is an electro-optical modulator which is arranged to modulate an optical signal in response to an electrical input (drive) signal V_{I1}, V_{I2}, V_{Q1}, V_{Q2}.

The first modulation apparatus 20 is coupled to the first output 11 of the splitter A and is arranged to apply a modulation scheme having 2ⁿ⁻² constellation points to produce a first modulated optical signal 26 representing an in-phase component. Stated another way, the optical signal is modulated to one of 2ⁿ⁻² constellation points. The second optical modulation apparatus 30 is coupled to the second output 12 of the splitter A and is arranged to apply a modulation scheme having 2ⁿ⁻² constellation points to produce a second modulated optical signal 36 representing a quadrature component. The second optical modulation apparatus 30 is arranged to firstly modulate a received optical signal by applying a modulation scheme having 2ⁿ⁻² constellation points to produce an intermediate modulated optical signal and then, secondly, a phase rotator 38 is arranged to apply a phase rotation to the intermediate modulated optical signal to produce the second modulated optical signal. The phase rotator applies a phase rotation to the intermediate modulated optical signal to produce the second modulated optical signal 36. The phase rotator 38 applies a phase rotation which causes a π/2 phase offset between the first modulated optical signal 26 and the second modulated optical signal 36. Phase rotator 38 is driven by a control signal V_{PM}. As shown in FIG. 2, the phase rotator 38 is positioned at the end of arm 12 to apply a phase rotation as a final step. It is also possible to apply this phase rotation variation at any other suitable position along the arm 12. The π/2 phase rotation is not an absolute phase variation, but is to impose a π/2 phase variation between a modulated signal 26 in arm 11 and a modulated signal 36 in arm 12.

FIG. 2 shows constellations for a square 16-QAM modulation scheme. The first modulation apparatus 20 is arranged to modulate an optical signal flowing along arm 11 by applying to one of 2ⁿ⁻² constellation points which are linearly arranged along the I-axis and the second modulation apparatus 30 is arranged to modulate a received optical signal to one of 2ⁿ⁻² constellation points which are linearly arranged along the Q-axis.

An optical combiner 40 couples to an output of the first modulation apparatus 20 and an output of the second modulation apparatus 30 and has an output 42. Optical combiner 40 is arranged to combine the first modulated optical signal and the second modulated optical signal to produce an output modulated optical signal which is modulated to one of 2ⁿ constellation points. Each of the first optical modulation apparatus 20 and the second optical modulation apparatus 30 comprises a dual-drive Mach Zehnder modulator having an input optical splitter B, C with an unequal split ratio.

In the embodiment shown in FIG. 2, the splitters B and C are designed to be unbalanced. The split ratio of splitter B is 80/20 and the split ratio of splitter C is 80/20. A power splitting ratio of 80/20 corresponds to an amplitude ratio of 2. In the I-arm, a four-level amplitude and phase shift keying (4-APSK) signal is generated, with logic values −3, −1, +1, +3, corresponding to the in-phase (I) component of the target 16-QAM constellation. In the same way, the Q-arm provides a second 4-APSK signal, corresponding to the quadrature (Q) component.

FIG. 2 also shows a driver circuit 50. Driver circuit 50 has an input for receiving a data signal and a set of outputs. The driver circuit 50 is arranged to output the first and second modulating signals (V_{I1}, V_{I2}) for the first modulation apparatus 20 with substantially equal peak-to-peak voltages Vₚₚ. The driver circuit 50 is arranged to output the first and second modulating signals (V_{Q1}, V_{Q2}) for the second modulation apparatus 30 with substantially equal peak-to-peak voltages Vₚₚ. The driver circuit 50 is also arranged to output the first and second modulating signals (V_{I1}, V_{I2}) for the first modulation apparatus 20 with a peak-to-peak voltage for causing a π phase shift between the first arm and the second arm of the modulator 20. Similarly, the driver circuit 50 is also arranged to output the first and second modulating signals (V_{Q1}, V_{Q2}) for the second modulation apparatus 30 with a peak-to-peak voltage for causing a π phase shift between the first arm and the second arm of the modulator 30. V_{PM} is a DC voltage used as a bias. Each phase modulator 23, 24, 33, 34 uses a bias voltage in addition to the RF voltages V_{I1}, V_{I2}, V_{Q1} and V_{Q2}. These bias voltages together with V_{PM} can be controlled by some feedback circuits as in conventional IQ modulators.

In general, if the transmission system generates binary signals as input data, those signals can be just used as V_{I1}, V_{I2}, V_{Q1} and V_{Q2}. The only kind of drivers needed in that case are limiting RF driver amplifiers ensuring a suitable peak-to-peak voltage Vₚₚ for each driving signal before reaching the modulator. In a case of higher-order 2ⁿ QAM schemes (n>4) a DAC may be required to produce multi-level drive signals. In the 16-QAM case this is not required and binary signals can be used.

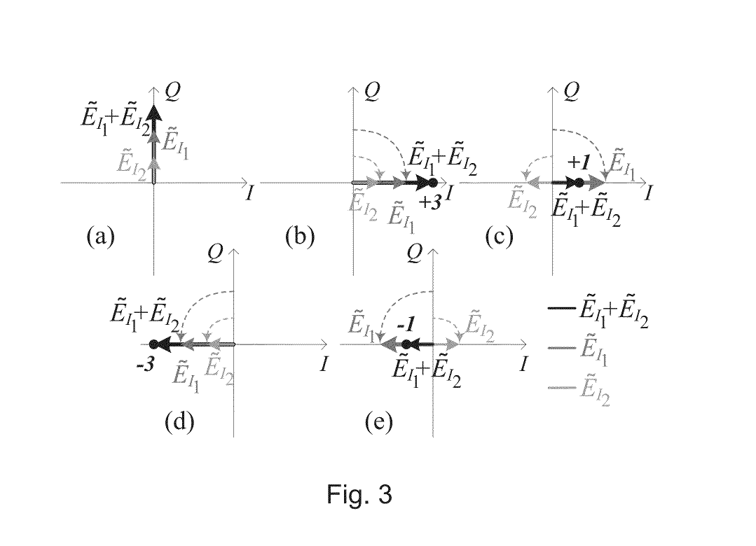

FIG. 3 shows generation of the 4-APSK signals in the I-arm of the modulator. Due to the unbalanced splitter B, the optical field E_{I1} propagating in arm I₁ 21 will be twice in amplitude with respect to the optical field E_{I2} propagating in arm I₂ 22. The I-arm MZM is driven by two binary signals with equal peak-to-peak amplitudes, V_{I1} and V_{I2} (V_{Q1} and V_{Q2} are used for the Q-arm). The induced phase shifts φ_{I1} and φ_{I2} are assumed to be proportional to the applied signals V_{I1} and V_{I2} and given by:

$${φ}_{I 1} = π \frac{{V}_{I 1}}{{V}_{π}}$$

$${φ}_{I 2} = π \frac{{V}_{I 2}}{{V}_{π}}$$

where V_{π} is the half wave voltage of each of the five phase shifters in FIG. 2. The MZM can be biased either at a maximum or a minimum of its transfer function. As an example, we consider the MZM biased at a peak (as shown in FIG. 3a), and two binary signals V_{I1} and V_{I2} assuming two possible values: ±Vₚₚ/2, where Vₚₚ is the peak-to-peak voltage. Advantageously, for proper operation and for exploiting the full available modulation dynamic range, Vₚₚ is set equal to V_{π} for all of the driving signals. This ensures that a transition from a logic 0 (logic 1) to a logic 1 (logic 0) induces a π (−π) phase shift on the optical field it is applied to. When both the applied signals are low (Vₚₚ/2), then φ_{I1}=φ_{I2}=−π/2 and constructive interference is preserved as the two phasors rotate by the same angle, producing logic symbol +3 (FIG. 3b). Similarly, when both signals are high (+Vₚₚ/2), then φ_{I1}=φ_{I2}=π/2 and logic symbol −3 is produced (FIG. 3d). On the contrary, when the two applied signals have opposite polarity, φ_{I1}=−φ_{I2} and the interference is destructive as the two phasors rotate oppositely thus producing logic symbols +1 and −1 (FIG. 3c and FIG. 3e, respectively). The optical fields, E_{I1} and E_{I2}, therefore combine constructively or destructively, depending on the applied binary signals, generating the 4-APSK signal that represents the I component of the 16-QAM. Owing to the complete π phase shift, the imaginary part is completely suppressed and the four points lie exactly on the I-axis free of any offset. Note that the splitting ratio between arms I₁ and I₂ is chosen to ensure that the four points of the 4-APSK are equally spaced along the I-axis.

Likewise, the Q-arm is used to synthesize a second 4-APSK corresponding to the Q component of the 16-QAM. By means of an additional phase shift on the Q-arm (achieved through the IQ bias V_{PM} in FIG. 2), these four points are positioned along the Q-axis, as the additional phase shifter (38, FIG. 2) applies a phase shift on the Q-arm so as to achieve a π/2 phase difference with respect to the constellation produced in the I-arm. Finally, by combining the I and Q components, an offset-free 16-QAM constellation is obtained.

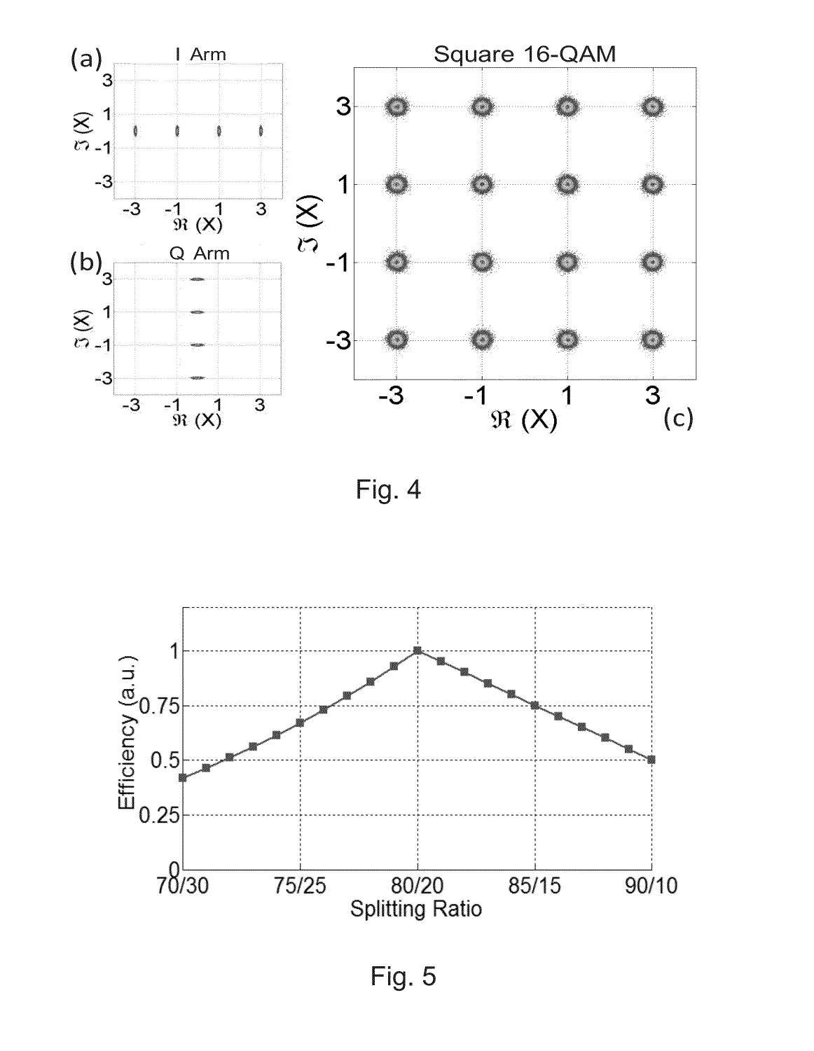

The effectiveness of the scheme is demonstrated through simulations. FIG. 4 shows plots of the 4-APSK signals generated in the I-arm (a) and the Q-arm (b) as well as the complete square 16-QAM constellation (c). Note that the additive white Gaussian noise considered for the four binary signals translates into phase noise on the I and Q components. Note that a vectorial sum of the 2ⁿ⁻² (2ⁿ⁻²=4 in this example) constellation points of the first optical modulation apparatus 20 has a zero DC offset. Similarly, a vectorial sum of the 2ⁿ⁻² (i.e. 4) constellation points of the second optical modulation apparatus 30 has a zero DC offset. The zero DC offset has an advantage of reduced energy consumption. If the constellation exhibits a DC term, the mean energy per bit increases, thus decreasing the efficiency.

One of the technical challenges in a practical implementation of the proposed scheme is a potential deviation from the optimal splitting ratios. FIG. 5 shows a plot reporting the impact on the constellation efficiency of such deviation for the two 80/20 splitting ratios present in the scheme, assuming the input 50/50 coupler A is ideal. The efficiency, normalized to the ideal case, has been calculated as the square of the minimum symbol distance over the mean energy per bit.

Advantageously, at least the splitters B, C are tunable, such that their split ratio can be adjusted. By providing tunable splitters, it is possible to perform fine-tuning of the splitting ratio to obtain a required splitting ratio for the unbalanced splitters B, C, such as an 80/20 splitting ratio. Providing tunable splitters can also allow for a coarser adjustment of splitting ratio to other desired splitting ratios, such as splitting ratios for other QAM constellation patterns.

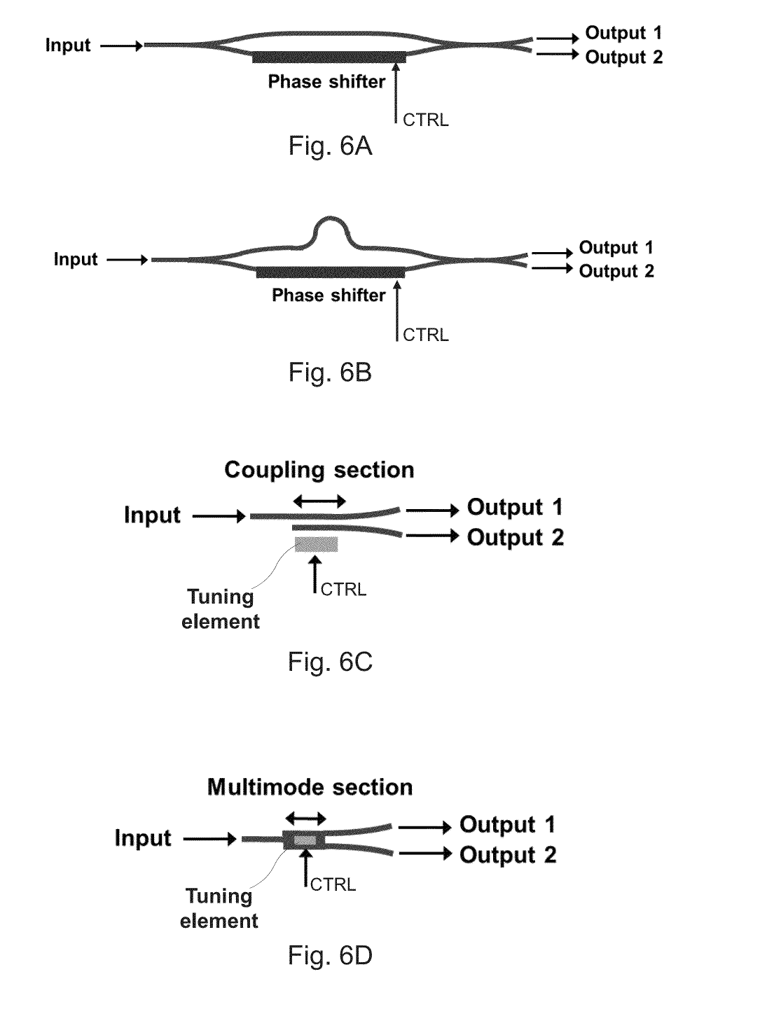

FIGS. 6A-6D show some possible ways in which tunable splitters can be realised. FIG. 6A shows a 1×2 MZI as a splitter with a phase shifter which can be adjusted by applying a control signal CTRL. The MZI is designed to exhibit a nominal output splitting ratio of 50/50, without any applied phase shift. With a phase shift induced, the output coupler can produce other splitting ratios such as the 80/20. FIG. 6B shows an unbalanced MZI with a phase shifter which can be adjusted by applying a control signal CTRL. The use of an unbalanced MZI can minimise the amount of tuning required. In the unbalanced MZI, a path length difference is introduced so that the nominal output splitting ratio is 80:20. After fabrication, just by applying a fine phase shift it is possible to compensate for fabrication variability to achieve the 80/20 splitting ratio. In a case where it is required to obtain an 80/20 splitting ratio with the structure shown in FIG. 6A, a much higher phase shift will need to be induced compared to FIG. 6B. FIG. 6C shows a directional coupler (DC) incorporating a splitting ratio tuning mechanism which can be adjusted by applying a control signal CTRL. FIG. 6D shows a multimode interference (MMI) coupler incorporating a splitting ratio tuning mechanism which can be adjusted by applying a control signal CTRL. A MZI-based splitter allows for wide tunability and offers relatively wide bandwidth. Tunable splitters not only allow for tuning to different precise splitting ratios as required for the 2ⁿ-QAM transmitter, but also increase the fabrication tolerances eliminating the need for post-process trimming.

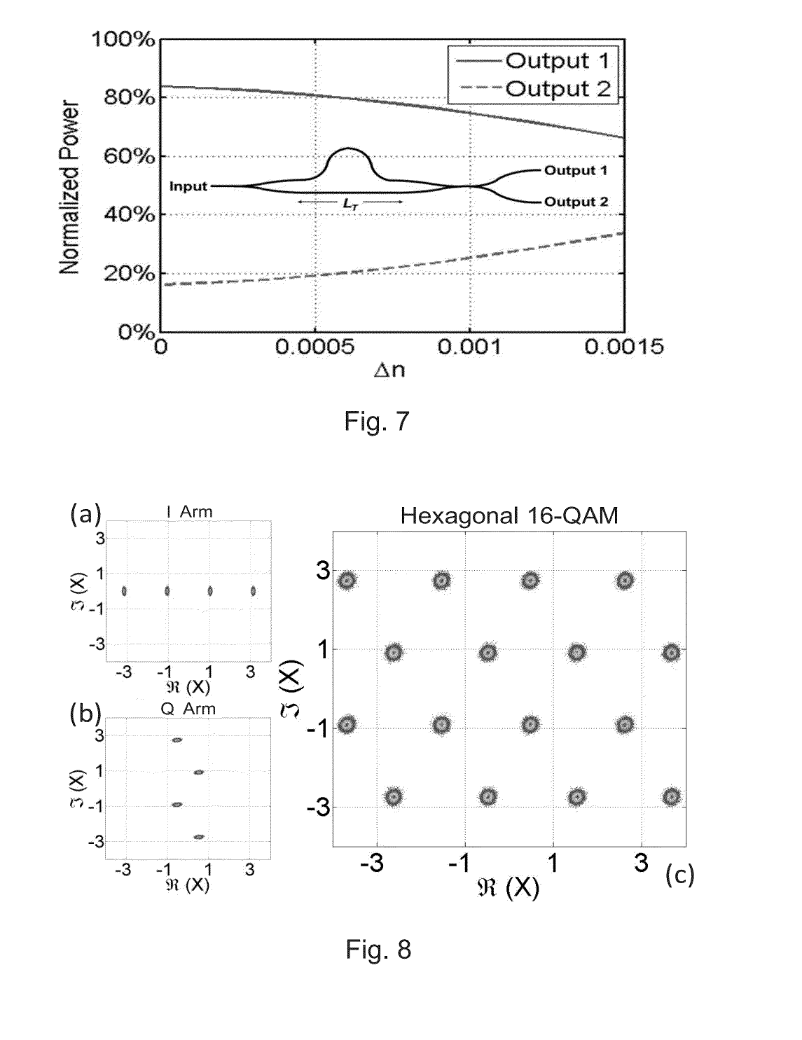

FIG. 7 shows the results of a beam propagation method simulation for a MZI splitter that is intentionally designed for a splitting ratio slightly different than 80/20 to account for potential fabrication variability. The splitter can then be precisely tuned to 80/20 or other splitting by injecting current across the SOI rib waveguide to induce the thermo-optic effect. For an interaction length of only 150 μm, the splitting ratio is tuned precisely to 80/20 with an index change of 5×10⁻⁴, which corresponds to a temperature increase of only 2.7° C. in Si. In this simulation, the tunable splitter is an unbalanced 1×2 MZI with a 80/20 split ratio required for the square 16-QAM transmitter. Simulations were performed for a 220-nm thick Silicon on insulator (SOI) rib waveguide structure, which would rely on the fairly efficient thermo-optic effect for tuning.

Advantageously, the first optical splitter A provided at the input to the modulator can be realised as a tunable splitter. For example, a tunable MZI splitter can be used to allow for fine tuning between the I-arm and Q-arm. Any of the options shown in FIGS. 6A-6D can be used to achieve tunability.

Tunable splitters also enable the realization of more efficient constellations. One example of a more efficient constellation is a hexagonal 2ⁿ-QAM, such as hexagonal 16-QAM. A hexagonal 16-QAM constellation can be generated by tuning splitter A to a splitting ratio of 55/45 and tuning splitter C to a splitting ratio of 75/25. Splitter B can remain at a splitting ratio of 80/20. Tuning to a splitting ratio of 75/25 from 80/20 splitting ratio, for example, requires only an additional temperature change of 2.6° C. In addition, the bias voltage of the modulator on the Q-arm has to be changed by a voltage equal to V_{π}/6. The electrical signal (V_{Q1} and V_{Q2}) applied to each phase modulator consists of the RF component and an additional DC term. Even in the case of the modulator biased at the characteristic peak there is a certain required DC bias voltage. Now it only has to be changed with respect to the previous case. The modulation working point is the difference of the two DC terms, each one applied to one phase modulator. In a case where a hexagonal constellation is required instead of a square constellation, the difference in DC voltages (or one of the two DC voltages) is changed by V_{π}/6.

FIG. 8 shows the I-arm and Q-arm outputs and corresponding output constellation for generation of hexagonal 16-QAM. Note that a vectorial sum of the 2ⁿ⁻² (i.e. 4) constellation points of the first optical modulation apparatus 20 has a zero DC offset. Similarly, a vectorial sum of the 2ⁿ⁻² (i.e. 4) constellation points of the second optical modulation apparatus 30 has a zero DC offset.

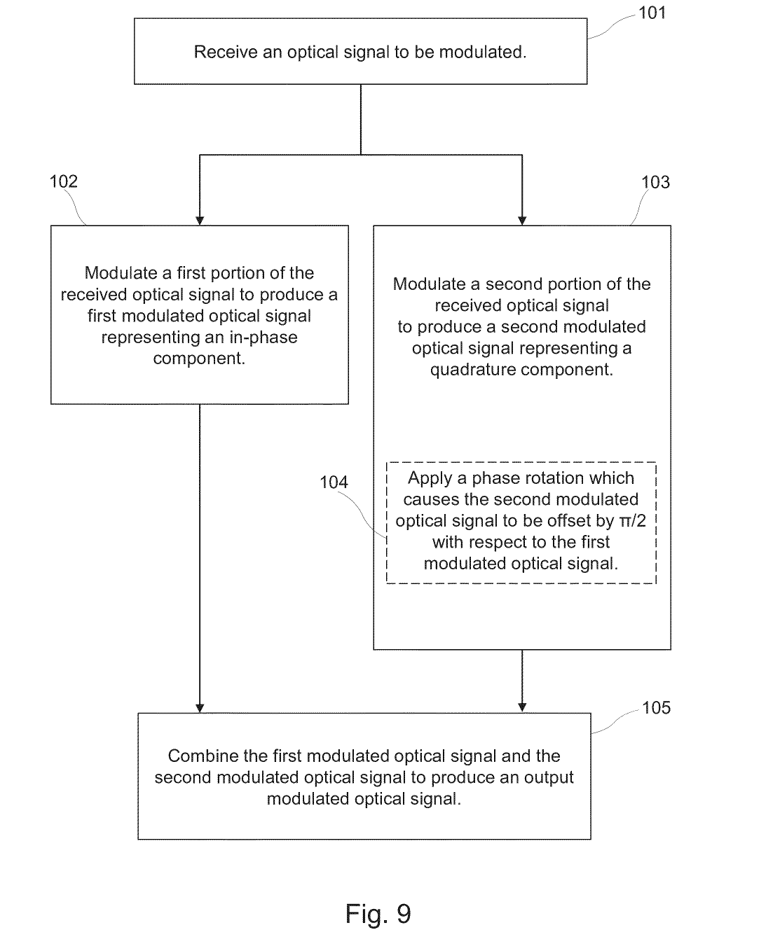

FIG. 9 shows a method of generating of 2ⁿ quadrature amplitude modulated signal. Step 101 comprises receiving an optical signal to be modulated. Step 102 comprises modulating a first portion of the received optical signal by applying a modulation scheme having 2ⁿ⁻² constellation points to produce a first modulated optical signal representing an in-phase component. Step 103 comprises modulating a second portion of the received optical signal by applying a modulation scheme having 2ⁿ⁻² constellation points to produce a second modulated optical signal representing a quadrature component. Step 105 comprises combining the first modulated optical signal and the second modulated optical signal to produce an output modulated optical signal which is modulated by a modulation scheme having 2ⁿ constellation points.

Each of the modulating steps uses a dual-drive Mach Zehnder modulator which splits the received optical signal with an unequal split ratio. Step 103 can comprise a step 104 of applying a phase rotation which causes the second modulated optical signal to be offset by π/2 with respect to the first modulated optical signal. Although the described embodiments relate to 16-QAM optical modulators and methods of 16-QAM optical modulation, it will be appreciated that the first optical modulation apparatus may be replaced by an optical modulation apparatus operable to apply a different 2ⁿ-QAM optical modulation scheme, such as a 64-QAM optical modulator and method of modulation. The electrical drive signals (V_{I1}, V_{I2}, V_{Q1}, V_{Q2}) which are applied to the phase modulators 23, 24, 33, 34 would be correspondingly changed, for example to 4 level drive signals in the case of 64-QAM optical modulation. Alternatively, the apparatus shown in FIG. 2 can be used with binary drive signals, and the apparatus can be coupled with another QPSK constellation resulting in a 64-QAM optical signal. A 16QAM modulator can be placed in parallel with a QPSK modulator to generate 64QAM. The 16QAM modulator output, coupled with a QPSK modulator output, would result in a 64QAM signal at the coupler output. Alternatively, by producing with the 16QAM modulator a 16QAM with a specific offset and subsequently, in series, placing a QPSK modulator, in principle it is possible to produce a 64QAM as well.

16-QAM is among the modulation format candidates for 100 Gb/s transmission into optical fibre. It is a multi-level signal, and is not trivial to generate using conventional optical modulators. The 2ⁿ-QAM optical modulator of the present invention enables a 16-QAM modulator to be provided which requires only two-level electrical driving signals, providing an advantage over multi-level drive signals which can be heavily distorted, due to bandwidth limitations and non-linearity of the modulator.

Embodiments described above provide a low-complexity architecture for a 2ⁿ-QAM optical transmitter, especially in the case of a 16-QAM transmitter, which is driven by four equal-amplitude binary signals only. Embodiments of the modulator and/or transmitter can be realized in an integrated format. The integrated circuit can be realized by exploiting Silicon Photonics technology, which offers a smaller footprint than previous demonstrations in both InP and LiNbO₃ and has also become a viable, low-cost and highly manufacturable platform for photonic integrated circuits. Current technology allows for the integration of phase modulators, low-loss passive components such as bends and splitters, as well as efficient fiber-to-chip coupling using either tapered edge couplers or vertical grating couplers.

In conclusion, a low-complex architecture for a 16-QAM optical transmitter has been reported. The architecture is based on tunable splitting ratio of the splitters present in the scheme, allowing to generate both offset-free square and hexagonal 16-QAM constellations. The transmitter can be easily integrated by exploiting Silicon Photonics technology with advantages in terms of footprint, cost and high manufacturability with respect to other platforms. The splitting ratios can be finely tuned to reconfigure the output constellation together with the compensation for imperfections related to the fabrication process.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A 2ⁿ quadrature amplitude modulation optical modulator comprising:
an optical input for receiving an optical signal;
a first optical splitter coupled to the optical input, the first optical splitter having a first output and a second output;
a first optical modulation apparatus coupled to the first output of the first optical splitter which is arranged to apply a modulation scheme having 2ⁿ⁻² constellation points to produce a first modulated optical signal representing an in-phase component;
a second optical modulation apparatus coupled to the second output of the first optical splitter which is arranged to apply a modulation scheme having 2ⁿ⁻² constellation point to produce a second modulated optical signal, representing a quadrature component;
an optical combiner for combining the first modulated optical signal and the second modulated optical signal to produce an output modulated optical signal which is modulated with a modulation scheme having 2ⁿ constellation points, wherein each of the first optical modulation apparatus and the second optical modulation apparatus comprises a dual-drive Mach Zehnder modulator having an input optical splitter with an unequal split ratio.

2. The 2ⁿ quadrature amplitude modulation optical modulator according to claim 1 wherein a vectorial sum of the 2ⁿ⁻² constellation points of the modulation scheme of the first optical modulation apparatus has a zero DC offset and wherein a vectorial sum of the 2ⁿ⁻² constellation points of the modulation scheme of the second optical modulation apparatus has a zero DC offset.

3. The 2ⁿ quadrature amplitude modulation optical modulator according to claim 1 wherein each of the first optical modulation apparatus and the second optical modulation apparatus comprise a first arm having an input for receiving a first electrical modulating signal and a second arm having an input for receiving a second electrical modulating signal, and wherein the optical modulator further comprises a driver circuit which is arranged to receive a data signal input and to output the first and second modulating signals with substantially equal peak-to-peak voltages.

4. The 2ⁿ quadrature amplitude modulation optical modulator according to claim 3 wherein the driver circuit is arranged to output the first and second modulating signals with a peak-to-peak voltage for causing a π phase shift between the first arm and the second arm of the modulator.

5. The 2ⁿ quadrature amplitude modulation optical modulator according to claim 1 further comprising a phase rotator which is arranged to apply a phase rotation which causes the second modulated optical signal to be offset by π/2 with respect to the first modulated optical signal.

6. The 2ⁿ quadrature amplitude modulation optical modulator according to claim 1 wherein at least one of the input optical splitters has a tunable split ratio.

7. The 2ⁿ quadrature amplitude modulation optical modulator according to claim 6 wherein the first input optical splitter has a tunable split ratio.

8. The 2ⁿ quadrature amplitude modulation optical modulator according to claim 6 wherein at least one of the input optical splitters comprises one of:
a Mach Zehnder interferometer;
a directional coupler with a tuning element;
a multimode interference coupler with a tuning element.

9. The 2ⁿ quadrature amplitude modulation optical modulator according to claim 1 wherein the split ratio of the input optical splitter in the first optical modulation apparatus is 80/20 and the split ratio of the input optical splitter in the second optical modulation apparatus is 80/20.

10. The 2ⁿ quadrature amplitude modulation optical modulator according to claim 1 wherein the split ratio of the first optical splitter is 55/45, the split ratio of the input optical splitter in one of the first optical modulation apparatus and the second optical modulation apparatus is 75/25 and the split ratio of the input optical splitter in the other of the first optical modulation apparatus and the second optical modulation apparatus is 80/20.

11. The 2ⁿ quadrature amplitude modulation optical modulator according to claim 1 wherein n is an even number and is at least 4.

12. The 2ⁿ quadrature amplitude modulation optical modulator according to claim 1 wherein n is 4.

13. An optical signal transmission apparatus comprising:
an optical source having an optical output for emitting an optical signal;
a 2ⁿ quadrature amplitude modulation optical modulator according to claim 1, wherein the optical output of the optical source is coupled to the optical input of the modulator.

14. A method of 2ⁿ quadrature amplitude modulation comprising:
receiving an optical signal to be modulated;
modulating a first portion of the received optical signal with a modulation scheme having 2ⁿ⁻² constellation points to produce a first modulated optical signal representing an in-phase component;
modulating a second portion of the received optical signal with a modulation scheme having 2ⁿ⁻² constellation points to produce a second modulated optical signal representing a quadrature component;
combining the first modulated optical signal and the second modulated optical signal to produce an output modulated optical signal which is modulated with a modulation scheme having 2ⁿ constellation points,
wherein each of the modulating steps uses a dual-drive Mach Zehnder modulator which splits the received optical signal with an unequal split ratio.

15. The method according to claim 14 wherein a vectorial sum of the 2ⁿ⁻² constellation points of the modulation scheme of the first optical modulation apparatus has a zero DC offset and a vectorial sum of the 2ⁿ⁻² constellation points of the modulation scheme of the second optical modulation apparatus has a zero DC offset.

16. The method according to claim 14 wherein the step of modulating a second portion of the received optical signal comprises applying a phase rotation which causes the second modulated optical signal to be offset by π/2 with respect to the first modulated optical signal.

17. The method according to claim 14 wherein the steps of modulating a first portion of the received optical signal and modulating a second portion of the received optical signal each use a first electrical modulating signal and a second electrical modulating signal and the method further comprises receiving a data signal input and outputting the first and second modulating signals with substantially equal peak-to-peak voltages.

18. The method according to claim 17 wherein the first and second modulating signals are output with a peak-to-peak voltage for causing a π phase shift between the first arm and the second arm of the modulator.
